(19) United States
(12) Patent Application Publication
(10) Pub. No.: US 2008/0158171 A1
(43) Pub. Date: Jul. 3, 2008

(54) Digitizer for flexible display

(76) Inventors: Hong W. Wong, Portland, OR (US); Wah Yiu Kwong, Beaverton, OR (US)

Correspondence Address: CAVEN & AGHEVLI;c/o INTELLEVATE, LLC, P.O. BOX 52050, MINNEAPOLIS, MN, 55402, US

(21) Appl. No.: 11/648,218

(22) Filed: Dec. 29, 2006

(51) Int. Cl. G06F 3/041

(52) U.S. Cl. 345/173

(57) ABSTRACT

Methods and apparatus to provide a digitizer for a flexible display are described. In one embodiment, a pressure sensitive sensor array may be coupled to a flexible display to detect touch input data. Also, a storage device to store data that is to be displayed on the flexible display may be provided in a housing that is coupled to the flexible display. Other embodiments are also described.

### BACKGROUND

The present disclosure generally relates to the field of electronics. More particularly, an embodiment of the invention generally relates to techniques for providing a digitizer for a flexible display.

As computing devices become more common-place, they may be operated in various environments. For example, flexible display devices may be used to display images. Flexible displays may some day replace the relatively bulkier computer monitors and rigid flat screens. Moreover, flexible displays may supplant paper for books, newspapers, and elsewhere in print. However, flexible displays may still need to be connected to a relatively bulky computer to be operational.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 2 illustrate various components of a flexible display with an integrated digitizer, according to some embodiments of the invention.

FIGS. 3 and 4 illustrate embodiments of flexible display systems, in accordance with some embodiments.

FIG. 5 illustrates a flow diagram of a method, according to an embodiment of the invention.

FIG. 6 illustrates a block diagram of a pressure sensitive sensor array, according to an embodiment.

FIG. 7 illustrates a block diagram of an embodiment of a computing system, which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

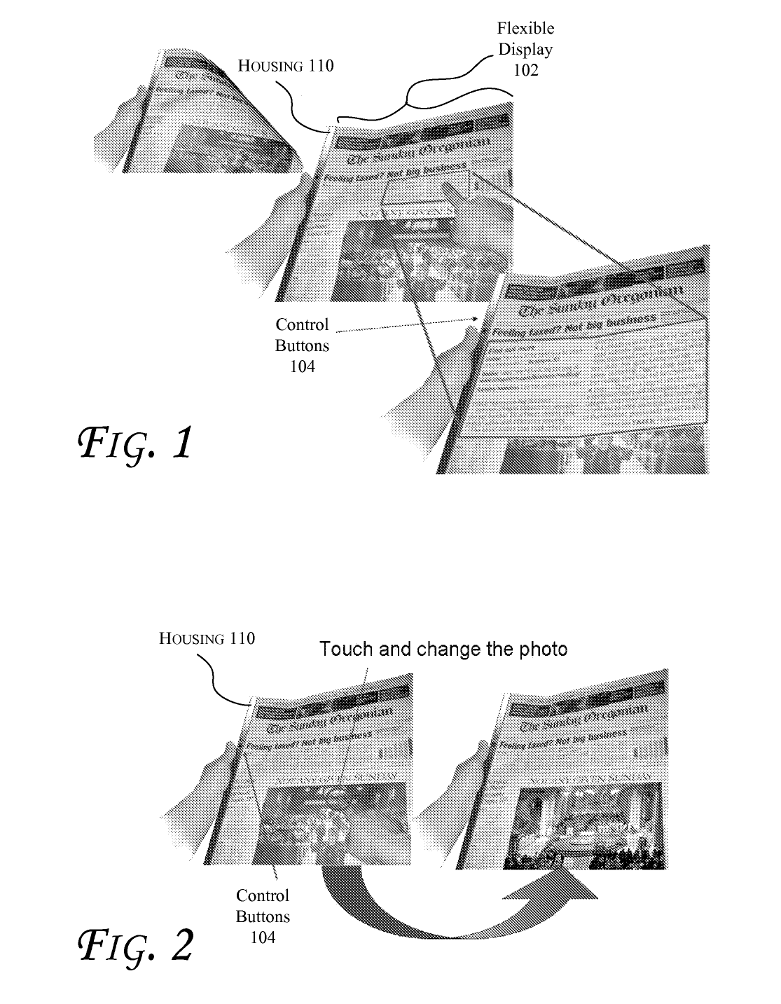

Some of the embodiments discussed herein may provide a digitizer for a flexible display. More particularly, FIGS. 1 and 2 illustrate various components of a flexible display with an integrated digitizer, according to some embodiments of the invention. As shown in FIGS. 1-2, a user may interact with a flexible display 102 by touch input and/or through one or more control buttons 104. For example, the user may touch a portion of the display 102 as shown in FIG. 1 to zoom in on the portion of interest. The user may further utilize the control button 104 to qualify the touch input and/or prevent error (e.g., by undoing an incorrect touch input). In FIG. 2, the user may touch and change a portion of the display 102, e.g., the photo on the left hand side may be replaced with the photo on the right hand side. Other browsing operations may also be performed by touching the flexible display 102, such as data input, page forward, page backward, zooming, etc. As discussed with reference to FIG. 1, the user may utilize the control button 104 to quality the touch input and/or prevent error (e.g., by undoing an incorrect touch input) in FIG. 2. Alternatively, the buttons 104 may be displayed on a portion of the flexible display, instead of or in addition to the housing 110. In some embodiments, besides being used as a display for a computer, the flexible display 102 may be used on other single function appliances, such as a device to display advertisement in a store/kiosk, or an electronic sign which also allows interactive touch input.

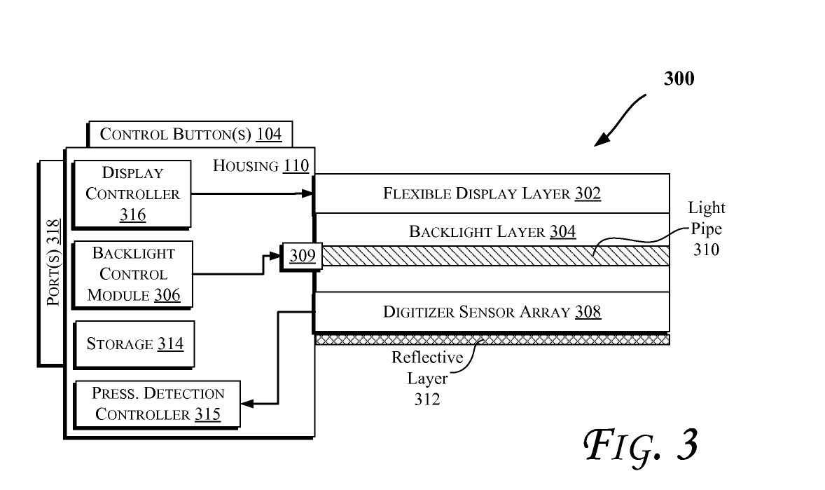

FIGS. 3 and 4 illustrate embodiments of flexible display systems 300 and 400, respectively, in accordance with some embodiments. A user may view images displayed on the systems 300 and 400 from the top side of the systems shown in FIGS. 3 and 4 in an embodiment.

The system 300 may include the housing 110, e.g., to provide a structure for housing various components such as a power source and/or electronics, including for example a battery, a power supply, power converter, and/or other components discussed herein. The system 300 may include a flexible display layer 302 (e.g., which may display images such as discussed with reference to the flexible display 102 of FIGS. 1-2), a backlight layer 304 (e.g., to provide electric laminate for backlighting of the flexible display layer 302), a backlight control module 306 (e.g., to control the intensity of backlight generated by the back layer 304), and a digitizer sensor array 308 (e.g., to detect touch input data). The backlight control module 306 may control the output of one or more light emitting diodes (LEDs) 309. In one embodiment, the layers 302, 304, 308, and/or 312 may be attached to each other (e.g., by using glue).

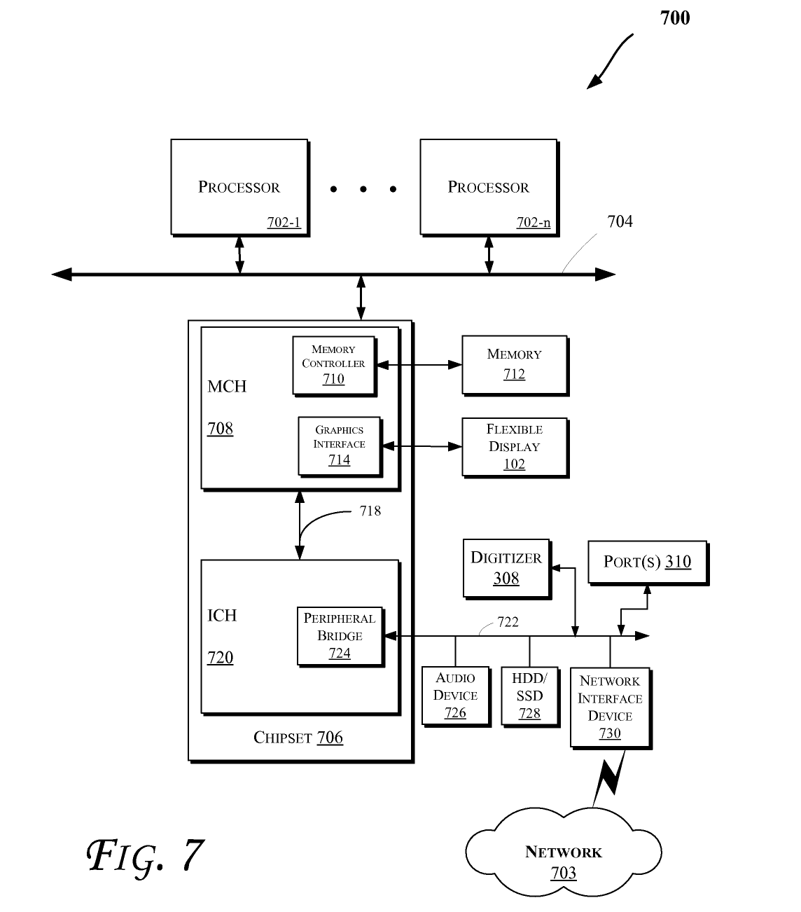

In an embodiment, the LEDs 309 may emit light rays from above or from the side of the backlight layer 304 through a flexible light pipe 310 such that the light rays may illuminate the backside of the flexible display layer 302. The light pipe 310 may be a silicon-based flexible pipe in an embodiment. Also, a reflective layer 312 may be provided on the backside of the system 300 (e.g., away from the side viewed by a user) to reflect light for higher brightness. The housing 110 may also include a storage unit 314, e.g., to store data corresponding to one or more images that are to be displayed through the flexible display layer 302. The system 300 may also include a display controller 316 to cause images to be displayed on the flexible display layer 302 (e.g., based on data stored in the storage unit 314). Additionally, the housing 110 may include one or more ports 318 to communicate data and/or power signals, such as one or more of a network port, an input device port (such as a keyboard or a pointing device), a power source port (e.g., to receive electrical power), an infra-red port, a universal serial bus port, a FireWire port, an audio port, a video port, a flash memory port, or an antenna port. Data communicated via the ports 318 may be stored in the storage unit 314, e.g., for subsequent display on the display layer 302. The housing 110 may include other components such as those discussed with reference to FIG. 7. Also, the housing 110 may include a roller (that may be spring loaded) to assist in retracting the flexible display assembly 102 (e.g., including layers 302-304 and the array 308) inside the housing 110 for storage. The roller may include a locking mechanism, e.g., such that the display assembly is not unrolled unintentionally.

In some embodiments, the sensor array 308 may include polymer silicon to provide pressure sensors on a flexible substrate. The touch input may be detected through the array 308 applied in implementations where the display layer 302 is a non-uniform surface, e.g., having a symmetric or non-symmetric surface. Such embodiments may be used instead of in conjunction with a resistive surface which utilizes a rigid, uniform or solid surface for the resistive film/layer to provide accurate location read out. Also, touch input may be provided through an inductive input surface, e.g., with an active or passive pen, which utilizes a uniform sensor grid surface in order to send/receive the electromagnet field. Further a capacitive input surface may be utilized. Moreover, ultrasonic signals may be used through a co-planar two-dimensional surface.

In an embodiment, the sensor array 308 may include arrays of Pentacene organic transistors that are built into a flexible substrate; which may be used to create a pressure-sensitive “skin” for touch input detection. The sensor arrays may be built layer by layer on polyimide films. For example, such a design may be realized with large-area printing technology to provide low-cost, flexible membranes that may imbue the systems 300 or 400 with a sense of touch similar to that of the human hand.

Furthermore, some embodiments may use flexible display touch input design with the following options: (1) a layer of the pressure sensitive material (308) may be placed (e.g., glued or attached) behind a flexible display layer (302). When pressure is applied on the display layer (302), e.g., by using a finger, the location of the applied pressure may be detected by the sensors (e.g., array 308 and realized by the controller 315) under the display layer (302) and a software application (e.g., stored in the storage unit 314) may respond to the input accordingly; or (2) the pressure sensors (308) may be printed on the flexible display (302) and the user input may be detected similarly to option (1). Option (2) may provide a lower cost than option (1).

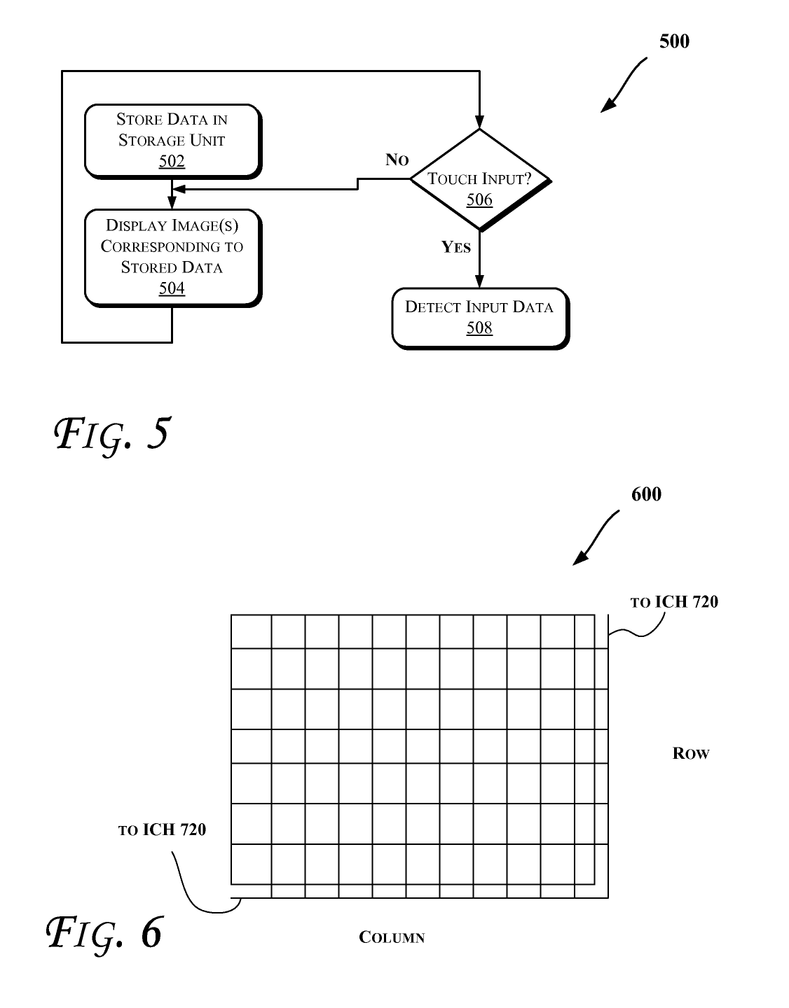

In some embodiments, the pressure-sensitive rubber layer (308) may contain electrically conductive graphite particles that change the layer's electrical resistance when pressure is applied. In an embodiment, this layer (308) may have a thickness of about half-millimeter and a copper electrode (or another metallic electrode) may be laminated to an array of organic transistors. Because the pressure-sensitive layer and the electrode may be un-patterned, the transistor assembly may be aligned, e.g., making the manufacturing process relatively simple. The sensors may be controlled by an active matrix (e.g., provided through the controller 315) that uses a transistor to record signals from each sensor in the array as will be discussed herein further, for example, with reference to FIG. 6. The active matrix may use one transistor in the on state for each stimulated sensor, which allows for lower power consumption and possibly greater control than simpler pressure sensor arrays that wire sensors together in grids. Organic or silicon transistors may be used by the active matrix. Organic transistors may be considerably larger and slower than the silicon transistors in some embodiments, but they may also be relatively cheap (e.g., organic transistors may be manufactured using a printing process).

Referring to FIG. 4, the system 400 may include one or more of the components discussed with reference to FIG. 3. However, the system 400 may provide the array 308 over the backlight layer 304, and flexible display layer 302. Also, the reflective layer 312 may be coupled to the flexile display layer 302 instead of the array 308.

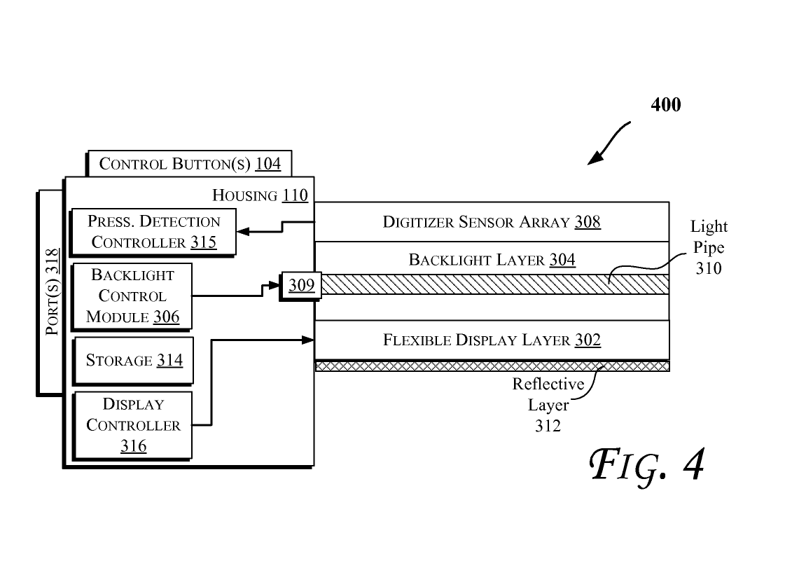

FIG. 5 illustrates a block diagram of an embodiment of a method 500 to detect touch input data. In an embodiment, the method 500 may be used to detect input data detected by the systems of FIGS. 3-4. In an embodiment, various components discussed with reference to FIGS. 1-4 and 6-7 may be utilized to perform one or more of the operations discussed with reference to FIG. 5.

Referring to FIGS. 1-5, at an operation 502, data corresponding to images that are to be displayed on a display device (e.g., the display layer 302) may be stored in a storage unit (e.g., the storage unit 314). At an operation 504, the images are displayed. At an operation 506, it is determined whether a touch input event has occurred (e.g., a user has pressed on the display layer 302). At an operation 508, the input data is detected (e.g., such as discussed herein via the pressure detection controller 315).

FIG. 6 illustrates a block diagram of a pressure sensitive sensor array 600, according to an embodiment. In one embodiment, the array 600 may be the same or similar to the array 308 discussed with reference to FIGS. 1-5. As shown in FIG. 6, the array 600 may include a grid of sensors organized in columns and rows. In an embodiment, a transistor (such as an organic transistor, a silicon transistor, or combinations thereof) may be present at each intersection of a column and a row. In one embodiment, the array 600 may represent an active matrix of pressure sensitive material such as discussed with reference to FIGS. 3-4. As shown in FIG. 6, the row and column signals may be coupled to an input/output control hub (ICH) 720 via a bus, e.g., a universal serial bus (USB), system management bus (SMBus), serial bus, peripheral component interconnect (PCI, which may comply with PCI Local Bus Specification, Revision 3.0, March 2004), PCI express (PCI-e, which may operate in accordance with PCIe Specification, Revision 2.0, October 2006), etc. which will be further discussed with reference to FIG. 7.

FIG. 7 illustrates a block diagram of an embodiment of a computing system 700. One or more of the components discussed with reference to FIG. 7 may be provided in the systems 300 and 400 of FIGS. 3 and 4, respectively. For example, one or more of the components 702 and 704-730 may be provided in the housing 110 in some embodiments. The computing system 700 may include one or more central processing unit(s) (CPUs) 702 or processors that communicate via an interconnection network (or bus) 704. The processors 702 may include a general purpose processor, a network processor (that processes data communicated over a computer network 703), or other types of a processor (including a reduced instruction set computer (RISC) processor or a complex instruction set computer (CISC)). Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. Moreover, the operations discussed with reference to FIGS. 1-6 may be performed by one or more components of the system 700.

A chipset 706 may also communicate with the interconnection network 704. The chipset 706 may include a memory control hub (MCH) 708. The MCH 708 may include a memory controller 710 that communicates with a memory 712. The memory 712 may store data, including sequences of instructions that are executed by the CPU 702, or any other device included in the computing system 700. In an embodiment, the memory 712 may be the same or similar to the storage unit 314 of FIGS. 3-4. In one embodiment of the invention, the memory 712 may include one or more volatile storage (or memory) devices such as random access memory (RAM), dynamic RAM (DRAM), synchronous DRAM (SDPAM), static RAM (SRAM), or other types of storage devices. Nonvolatile memory may also be utilized such as a hard disk. Additional devices may communicate via the interconnection network 704, such as multiple CPUs and/or multiple system memories.

The MCH 708 may also include a graphics interface 714 that communicates with the display 102. In one embodiment of the invention, the graphics interface 714 may communicate with the display 102 via an accelerated graphics port (AGP). In an embodiment of the invention, the graphics interface 714 may be the same or similar to the display controller 316 of FIGS. 3-4, that communicates with the display 102 through, for example, a signal converter that translates a digital representation of an image stored in a storage device such as video memory or system memory (e.g., memory 712 and/or storage unit 314) into display signals that are displayed by the display 102.

A hub interface 718 may allow the MCH 708 and an input/output control hub (ICH) 720 to communicate. The ICH 720 may provide an interface to I/O devices that communicate with the computing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the CPU 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 722 may communicate with an audio device 726, one or more hard disk drive(s) or solid state disks 728, and a network interface device 730, which may be in communication with the computer network 703. In an embodiment, the device 730 may be a NIC capable of wired or wireless communication. Further, as shown in FIG. 7, the digitizer sensor array 308 and/or port(s) 318 may be coupled to the ICH 720 through the bus 722. Alternatively, the digitizer 308 and/or port(s) 318 may communicate directly with the ICH 720.

In some embodiments, the network 703 may be a wired and/or wireless network. Also, data communicated over the network 703 may be encrypted (or cryptographically secured), e.g., to limit unauthorized access. Furthermore, the network 703 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire. Moreover, wireless communication through the network 703 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled) such as the device 730.

Other devices may communicate via the bus 722. Also, various components (such as the network interface device 730) may communicate with the MCH 708 in some embodiments of the invention. In addition, the processor 702 and the MCH 708 may be combined to form a single chip. Furthermore, the graphics accelerator 716 may be included within the MCH 708 in other embodiments of the invention.

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 700 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a flexible display;
a pressure sensitive sensor array coupled to the flexible display to detect touch input data; and
a housing having a storage device to store data corresponding to one or more images that are to be displayed on the flexible display.

2. The apparatus of claim 1, wherein the housing is to comprise one or more of: a button, a pressure detection controller, or a display controller.

3. The apparatus of claim 2, wherein the pressure detection controller is coupled to the pressure sensitive sensor array to detect the touch input data.

4. The apparatus of claim 2, wherein the button is to assist in browsing operations performed on the flexible display.

5. The apparatus of claim 2, wherein the display controller is coupled to the flexible display to cause one or more images to be displayed on the flexible display.

6. The apparatus of claim 1, wherein the housing is to comprise a network interface device to communicate data through a computer network via a wired or wireless connection.

7. The apparatus of claim 1, wherein the housing is to comprise a cellular interface device to communicate data through a cellular network.

8. The apparatus of claim 1, wherein the housing is to comprise one or more of a processor, a port, or a roller.

9. The apparatus of claim 7, wherein the port is one or more of a network port, an input device port, a power source port, an infra-red port, a universal serial bus port, a FireWire port, an audio port, a video port, a flash memory port, or an antenna port.

10. A method comprising:
detecting touch input data via a pressure sensitive sensor array coupled to a flexible display; and
storing data corresponding to one or more images that are to be displayed on the flexible display.

11. The method of claim 10, further comprising receiving the data through a wired or wireless network.

12. The method of claim 10, further comprising backlighting the flexible display.

13. The method of claim 12, further comprising providing the backlighting through light emitting diodes coupled to a light pipe.

14. The method of claim 10, further comprising receiving the data through one or more ports.

15. The method of claim 10, wherein detecting the touch input data comprises detecting activation of a transistor.
